(19) United States
(12) Patent Application Publication
(10) Pub. No.: US 2015/0025910 A1
(43) Pub. Date: Jan. 22, 2015

(54) Medical Billing and Coding Process

(71) Applicant: Mark F. Devens, Lombard, IL (US)

(72) Inventor: Mark F. Devens, Lombard, IL (US)

(21) Appl. No.: 14/330,578

(22) Filed: Jul. 14, 2014

Related U.S. Application Data
(60) Provisional application No. 61/846,927, filed on Jul. 16, 2013.

(51) Int. Cl. G06F 19/00

(52) U.S. Cl. CPC G06F 19/328; G06F 19/322
USPC 705/3

(57) ABSTRACT

In an embodiment, the present invention provides a medical billing and coding process, including the steps of storing in memory medical base codes and add-on codes, their descriptions, images of products corresponding to the codes, medical justifications for the codes, and ordering and pricing information for the products corresponding to each code. The process includes providing the medical base code and add-on code descriptions when selected, and providing medical justifications corresponding to a selected code. The process includes providing products corresponding to the selected codes, and providing ordering information for the products corresponding to the selected codes. The process includes rendering the image corresponding to the codes such that additional codes, their descriptions, and additional products associated with the codes may be viewed and selected.

### CROSS-REFERENCE TO RELATED APPLICATIONS

The present Application claims the benefit of U.S. Provisional Application No. 61/846,927, filed Jul. 16, 2013, the contents of which are incorporated herein by reference.

### FEDERALLY SPONSORED RESEARCH OR DEVELOPMENT

N/A

### TECHNICAL FIELD

The present invention generally relates to medical industry coding and billing, and in particular to a process that integrates coding, billing and product component coding and ordering.

### BACKGROUND OF THE INVENTION

A variety of medical coding and billing methods are currently available. Many of these methods are cumbersome and can require extensive training and knowledge in medical conditions, treatments, coding and methods. For instance, the current available methods do not integrate coding, billing, and product components to complete the data needed for patient records and files. In addition, currently available methods provide coding assistance with only rudimentary drawings and require a user to navigate to access the needed ‘add-on’ codes making such methods difficult and time-consuming for operators to work with. Further, the current methods do not provide detailed descriptions of the base codes or add-on codes along with medical justification for use of the particular codes.

In currently available methods one must access separate manufacturer sites to search for a particular product corresponding to a particular code. Also, when choosing base codes and add-on codes one has to navigate various screens and search by their own memory or knowledge the possible add-on codes along with descriptors and justifications.

Applicant's invention ‘bundles’ all the codes so that when a ‘base code’ is selected all available applicable ‘add-on’ codes are generated, and can then be chosen to complete the coding. Applicant's invention also applies a menu of descriptions and medical justifications that can be selected and addended to a particular code.

Furthermore, when a code is chosen using Applicant's invention, a menu of all available products that correspond to that particular code is also populated allowing the user to choose the desired product and place an order for such product. The new process allows navigation by using a portion of the picture or rendering of the item of a particular base code and while rolling the cursor over a specific portion, the various add-on codes, and other information are automatically projected via ‘pop-ups’ or menus. Further, the new software supplies pricing and ordering information attached to the product which is attached to the code, allowing the user to use one software program to code, describe, justify, select, price and order all in one seamless stream.

The coding and accompanying information can be submitted to third party payers or managed care organizations, doctors, hospitals, or purchasing departments via email complete with all the information needed to complete authorization, billing and product selection and ordering. The process of the present invention provides a streamlined, accurate, user-friendly process for medical billing and coding that includes integrating information from patient records with pre-entered information for product selection and ordering.

### SUMMARY OF THE INVENTION

In an embodiment, the present invention provides a medical billing and coding process. The process includes the steps of storing in memory medical base codes and add-on codes, descriptions of the medical base codes and add-on codes, images of products corresponding to the medical base codes and add-on codes, medical justifications for the medical base codes and add-on codes, and ordering and pricing information for the products corresponding to each medical base code and add-on code. The process also includes providing a menu of the medical base code and add-on code descriptions when a medical base code or add-on code is selected, and providing a menu of medical justifications corresponding to a selected medical base code and add-on code. The process further provides providing a menu of products corresponding to the selected medical base code and add-on codes, and providing ordering information for the products corresponding to the selected medical base codes and add-on codes. In addition, the process includes rendering the image corresponding to the medical base codes and add-on codes such that additional medical base codes and add-on codes, descriptions of the medical base codes and add-on codes, and additional products associated with the medical base codes and add-on codes may be viewed and selected from the image and menus.

In another embodiment, a medical billing and coding process is provided. The process includes the steps of storing in memory medical base codes, descriptions of the medical base codes, images corresponding to the medical base codes, medical justifications for the medical base codes, and ordering and pricing information corresponding to the products. The process also includes selecting at least one medical base code, and rendering the image corresponding to the medical base code. The image includes selectable portions such that a menu of the base code descriptions is provided when a first portion is selected from the image. In the process, a menu of the medical justifications for the selected base code is provided, as is a menu of products corresponding to the medical base code. The process also includes providing additional medical codes corresponding to the medical base code, and ordering information for the products.

In other embodiments, the present invention includes the steps of forwarding the selected information to a third party, selecting a product associated with the medical base code and additional medical codes, and ordering the selected product corresponding to the medical base code and additional medical codes.

### BRIEF DESCRIPTION OF THE DRAWINGS

To understand the present invention, it will now be described by way of example, with reference to the accompanying drawings in which:

FIG. 1 is a schematic view of the medical billing and coding process of an embodiment of the present invention.

FIG. 2 is a screen shot of the medical billing and coding process of an embodiment of the present invention.

FIG. 3 is a screen shot of the medical billing and coding process of an embodiment of the present invention.

FIG. 4 is a screen shot of the medical billing and coding process of an embodiment of the present invention.

FIG. 5 is a screen shot of the medical billing and coding process of an embodiment of the present invention.

FIG. 6 is a screen shot of the medical billing and coding process of an embodiment of the present invention.

FIG. 7 is a screen shot of the medical billing and coding process of an embodiment of the present invention.

FIG. 8 is a screen shot of the medical billing and coding process of an embodiment of the present invention.

FIG. 9 is a screen shot of the medical billing and coding process of an embodiment of the present invention.

FIG. 10 is a screen shot of the medical billing and coding process of an embodiment of the present invention.

FIG. 11 is a screen shot of the medical billing and coding process of an embodiment of the present invention.

FIG. 12 is a screen shot of the medical billing and coding process of an embodiment of the present invention.

FIG. 13 is a screen shot of the medical billing and coding process of an embodiment of the present invention.

FIG. 14 is a view of the medical billing and coding process of an embodiment of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

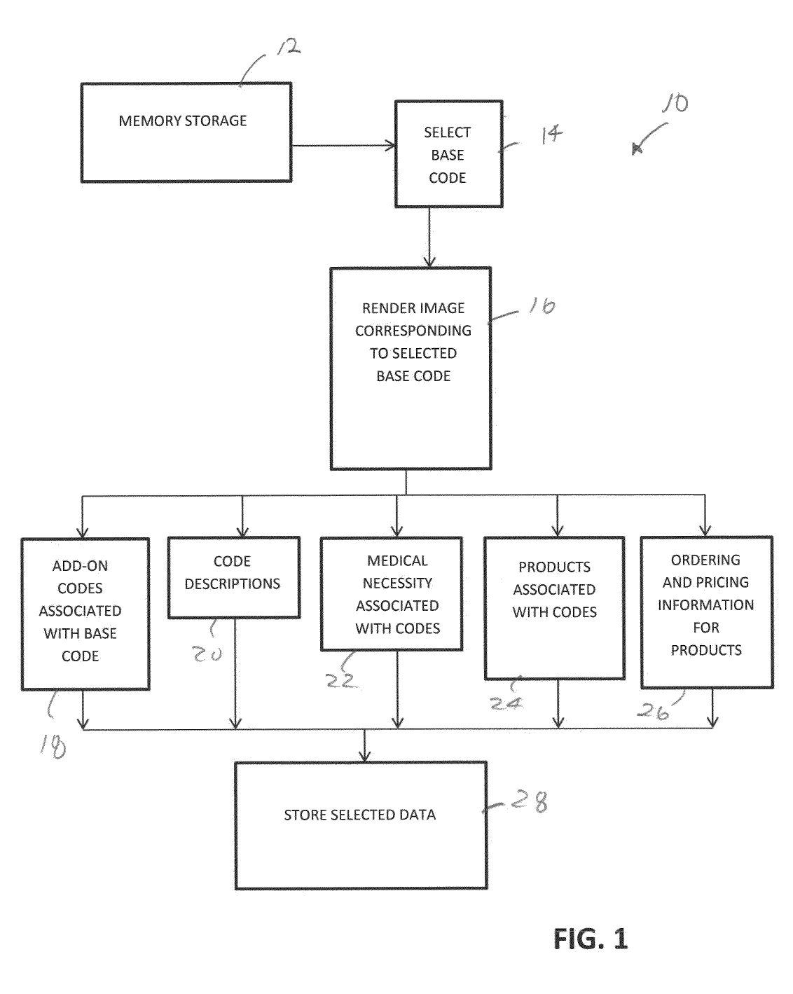

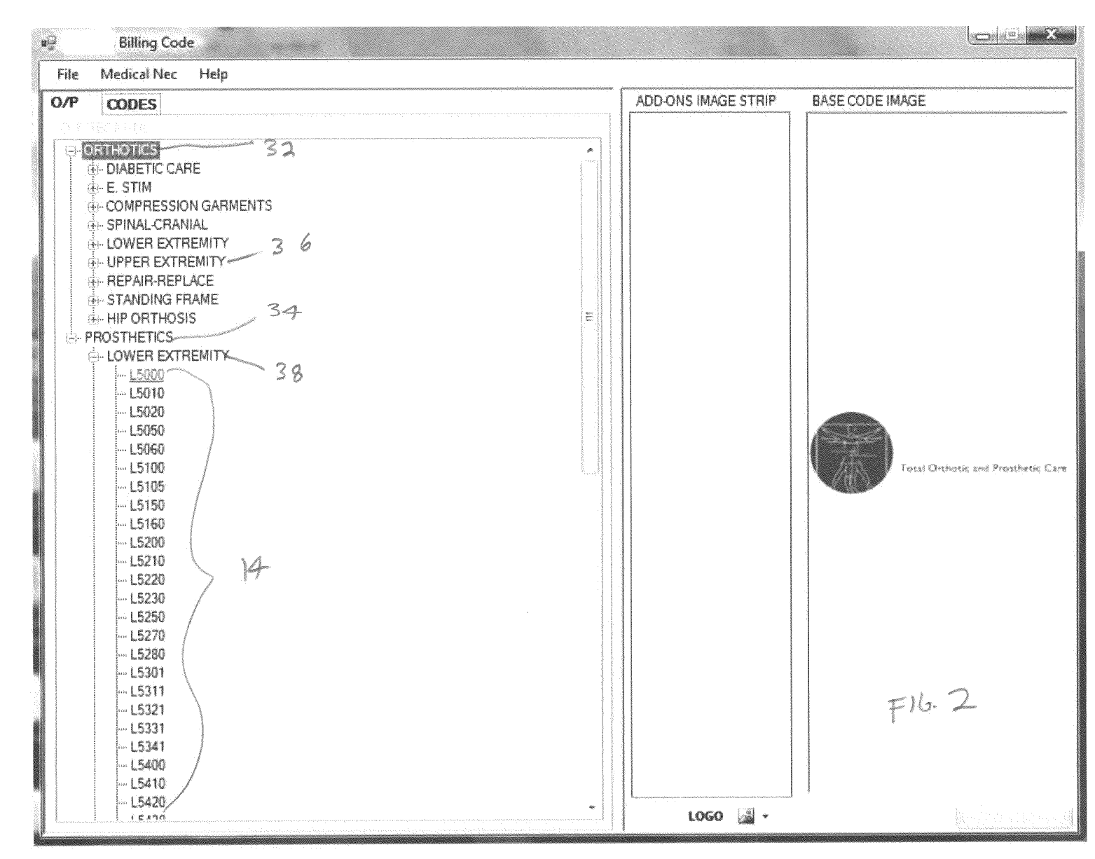

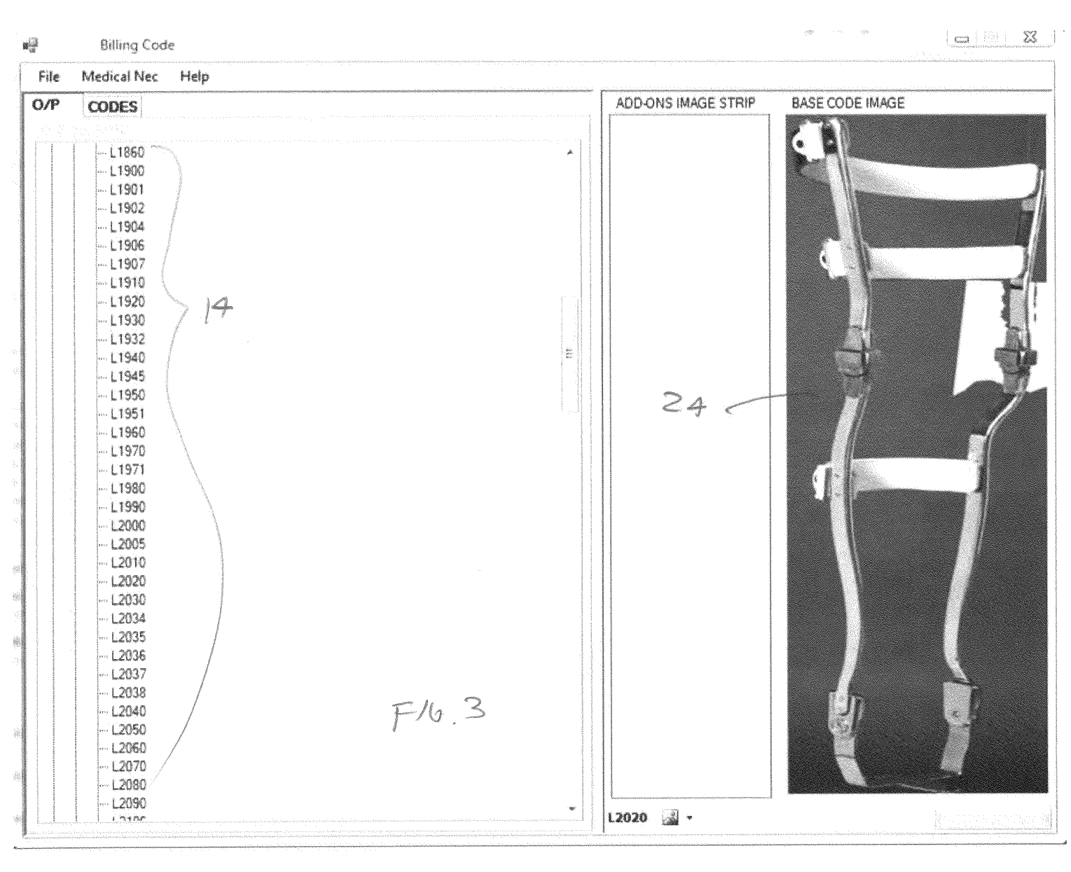

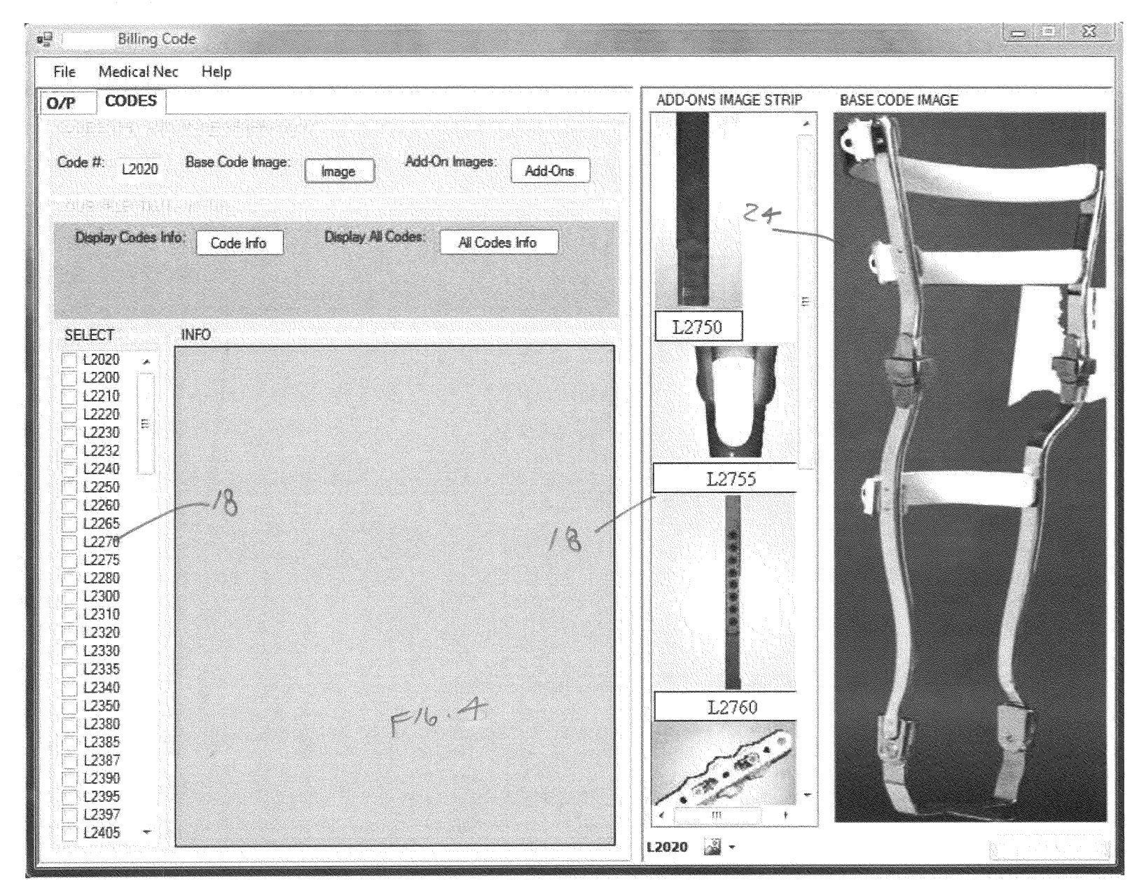

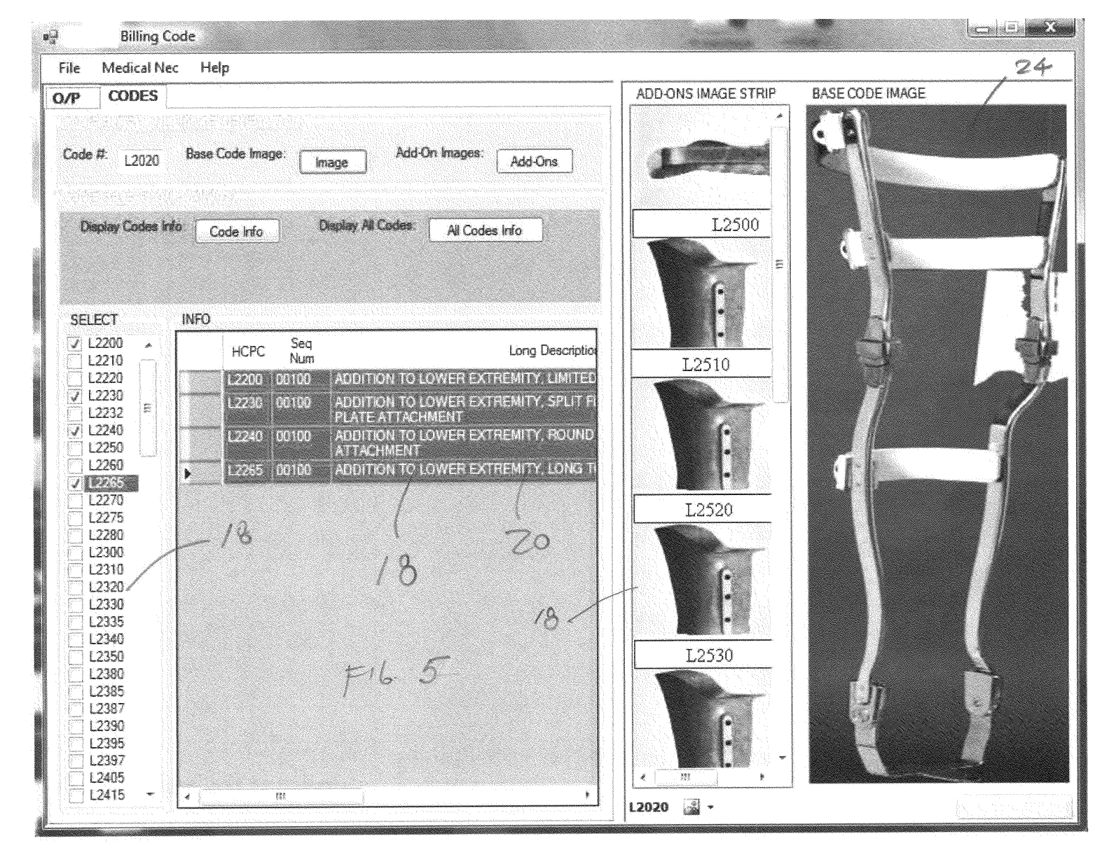

FIG. 1 shows a medical coding and billing process 10 of an embodiment of the present invention. The process 10 will be described with respect to medical coding and billing for prosthetic or orthotic devices, but may be used with any suitable medical or other field. The process 10 includes storing in memory 12 information regarding medical codes. These medical codes include base codes 14 and add-on codes 18. The add-on codes 18 are associated with particular base codes 14. An example of a base code 14 (FIG. 2) and its associated add-on codes 18 includes a base code of L2020 (FIGS. 2 through 6). The base code L2020 is for an orthotic device for a lower extremity as shown in FIGS. 2 and 3. The add-on codes 18 for base code L2020 are shown in FIGS. 4, 5 and 6.

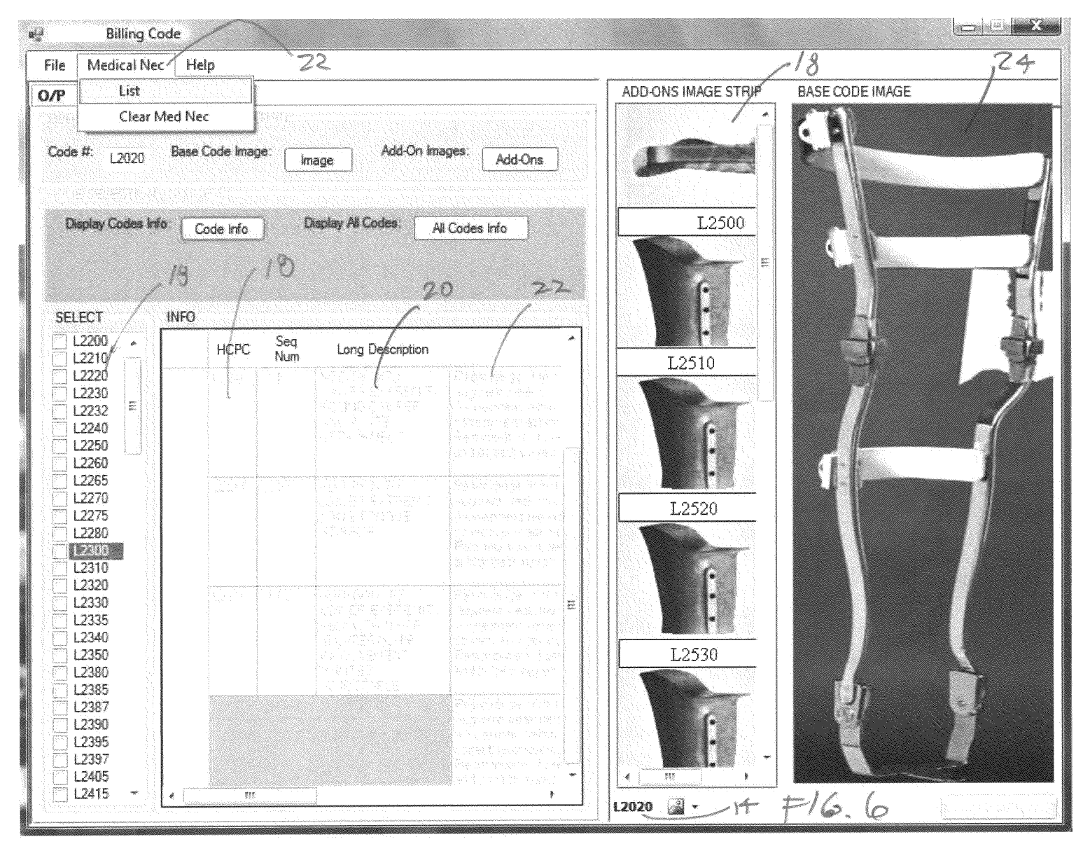

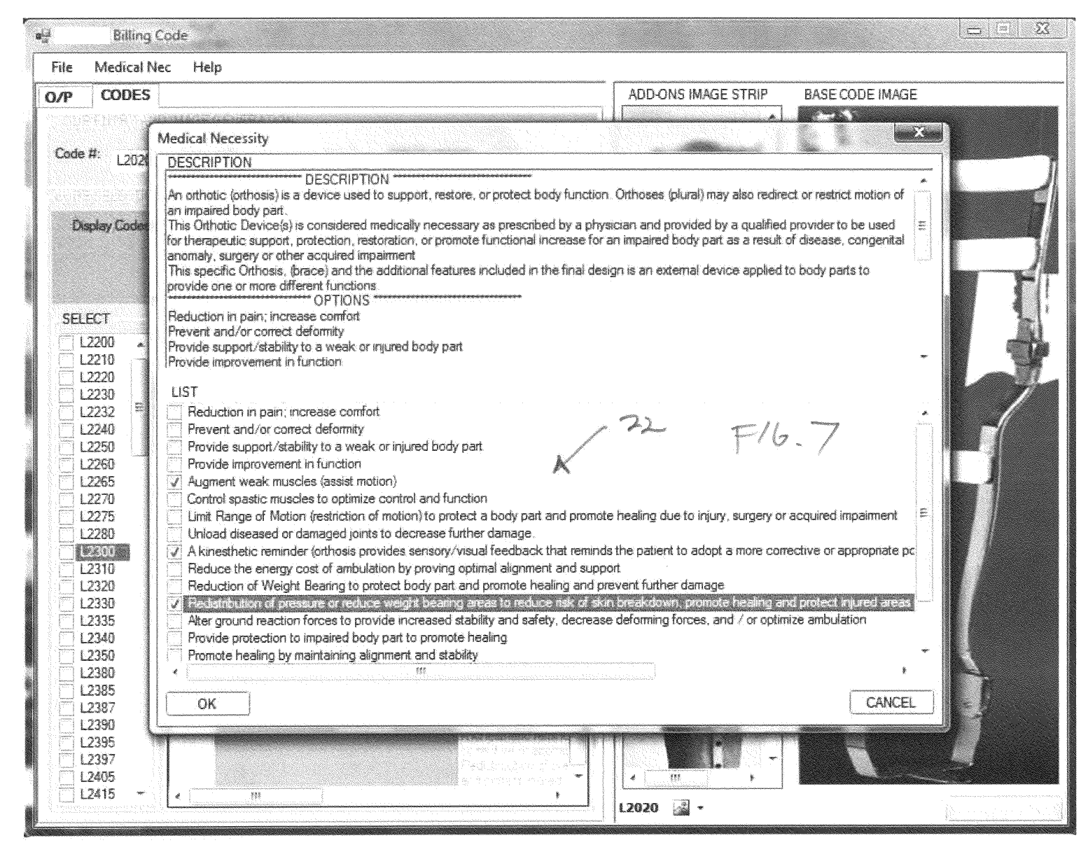

Additional information that is stored in the memory includes descriptions 20 of each of the base codes 14 and add-on codes 18 and the medical necessity 22 associated with each code 14 or 18. An example of a medical necessity 22 associated with a medical code 14 or 18 is shown in FIGS. 6 and 7. For the example of base code L2020, medical necessities 22 for the base code 14 and add-on codes 18 are listed, and can be selected based on the patient's particular needs.

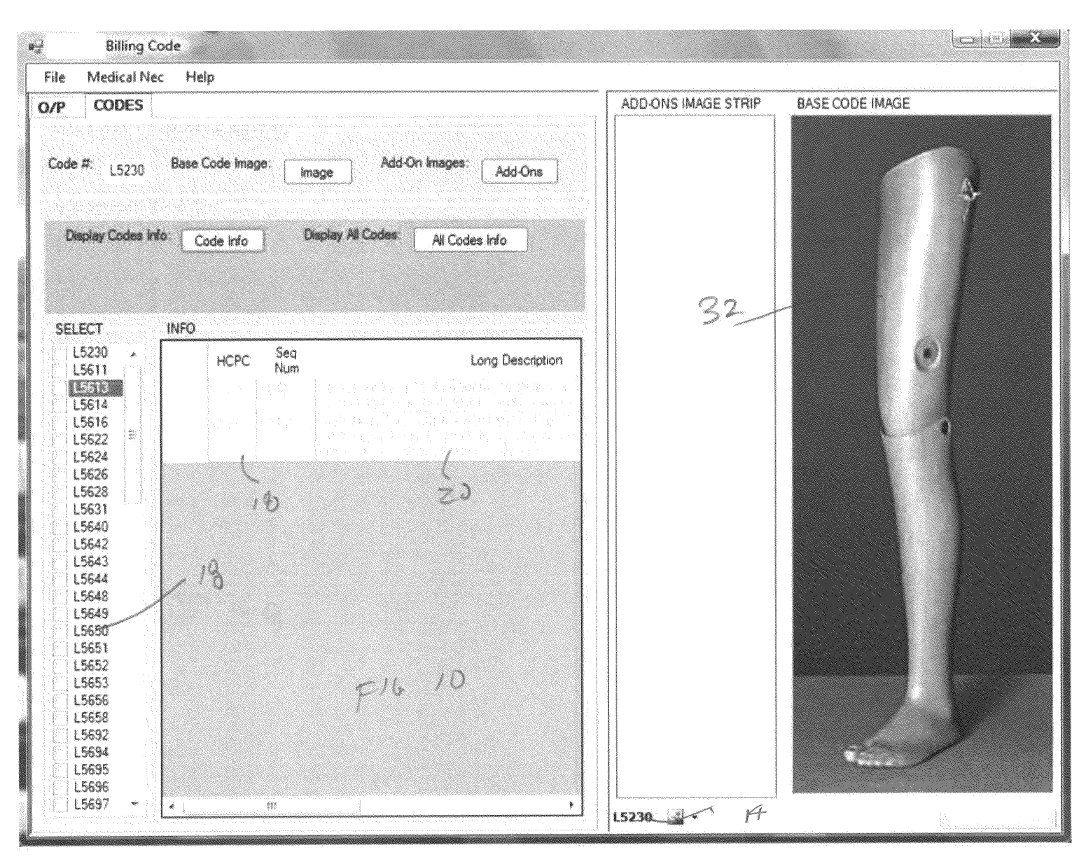

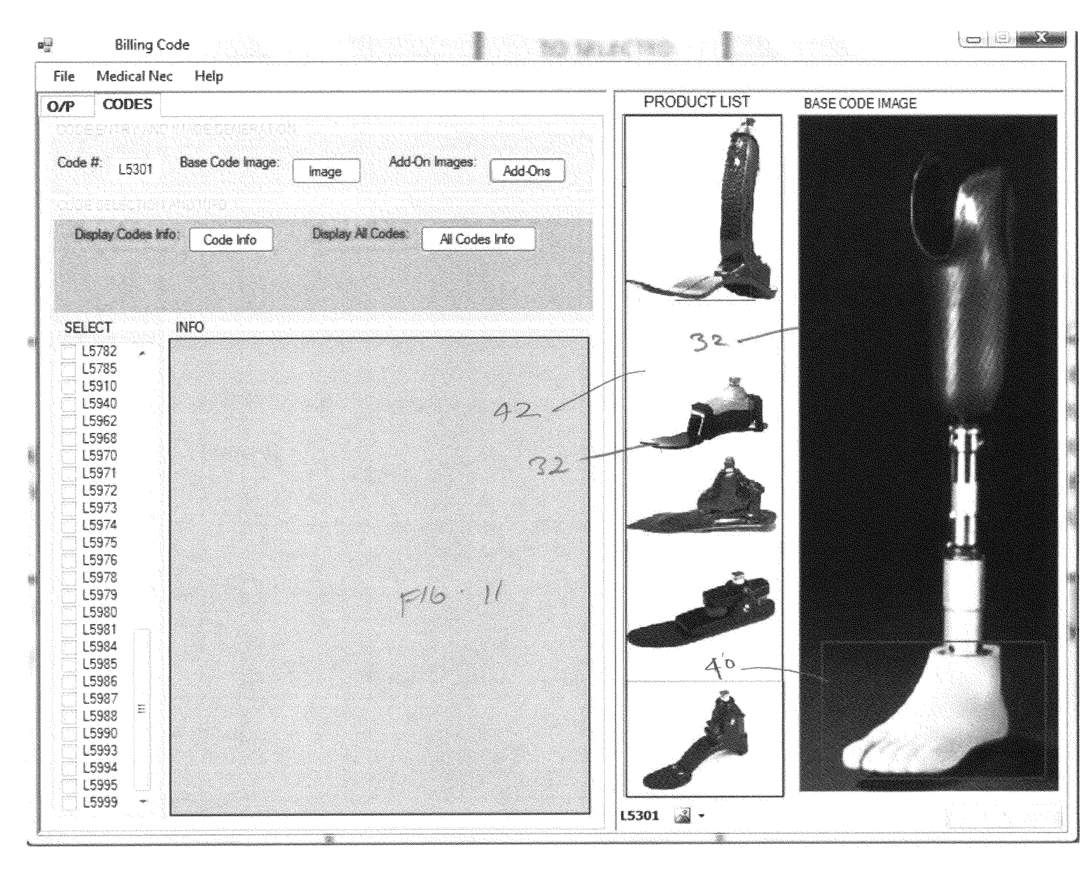

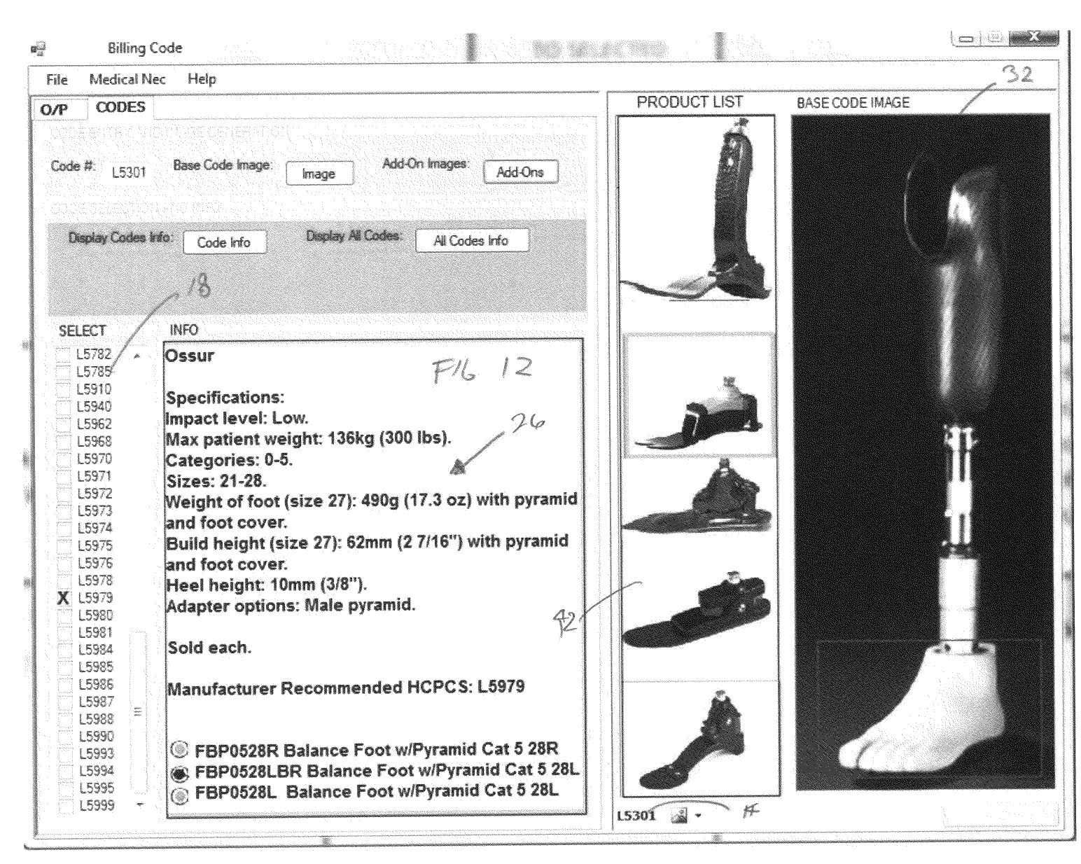

Also stored in the memory are descriptions and photographs of products 24 provided by manufacturers for prosthetic or orthotic devices that are associated with every base code 14 and add-on code 18. An example of such products 24 includes the lower extremity orthotic device associated with base code L2020 as shown in FIGS. 3 through 9. An additional example of a prosthetic product 32 is shown in FIGS. 10 through 12. These products 24 and 32 and their associated images are updated on a regular basis, or when necessary. Ordering and pricing information 26 for each of the products is also provided and stored in the memory as shown in FIG. 12.

The medical coder or biller begins the process 10 by selecting a base code 14 corresponding to a patient's particular medical need. The base code 14 corresponds to a particular medical condition. In an embodiment, the base codes 14 and their associated add-on codes 18 may be categorized, for example, under “Orthotics” 32 or “Prosthetics” 34 as shown in FIG. 2. The base codes may be further categorized by the area of the body for which treatment is desired, for example, “Upper Extremity,” 36 “Lower Extremity,” 38, and further under “Foot,” “Knee,” “Below Knee.” This will assist the biller or coder in making correct base code selections.

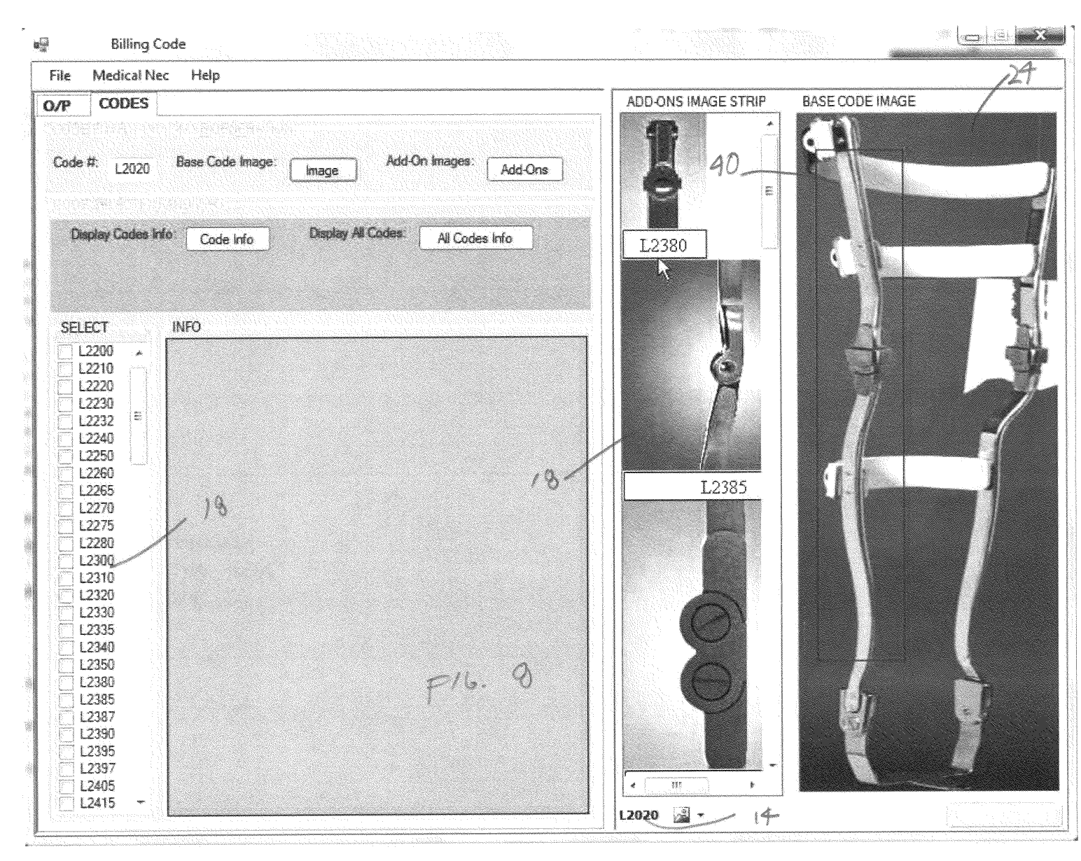

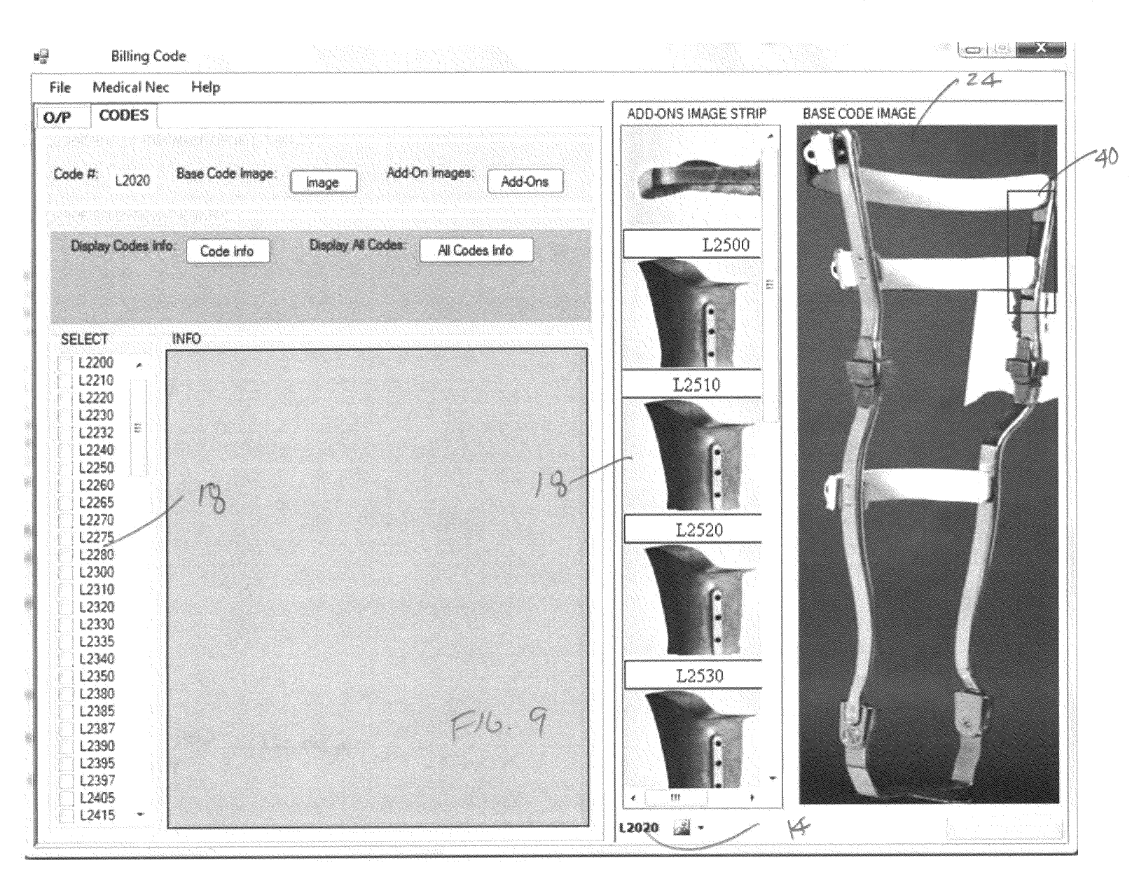

Once a base code 14 is selected, an image of a product 24 associated with the base code 14 is rendered 16 as shown in FIG. 2. The image of the product 24 is interactive, and provides the user with the ability to select from the image add-on codes 18 associated with the base codes 14 (FIGS. 8 and 9). The red box 40 shown in FIGS. 8 and 9 allow the user to select the add-on codes 18 associated with the product 24. Products 24 for the add-on codes 18 associated with the base code 14 product image 24 or 32 may be selected. The user will also be able to view descriptions 20 of all the base codes 14 and add-on codes 18 to help him or her select the appropriate base code 14 and add-on codes 18. The user will also be able to view a menu of medical necessities 22 associated with every base code 14 and add-on code 18. (FIGS. 6 and 7). The medical necessity 22 is presented as a list of medical reasons for each code, and the appropriate medical necessity 22 can be selected for the selected base 14 or add-on codes 18.

The user will also be able to view descriptions and ordering and pricing information for such products 26 as shown in FIG. 12. Photographs of the products and other marketing or product information can be included within stored information to allow the user to select the appropriate product.

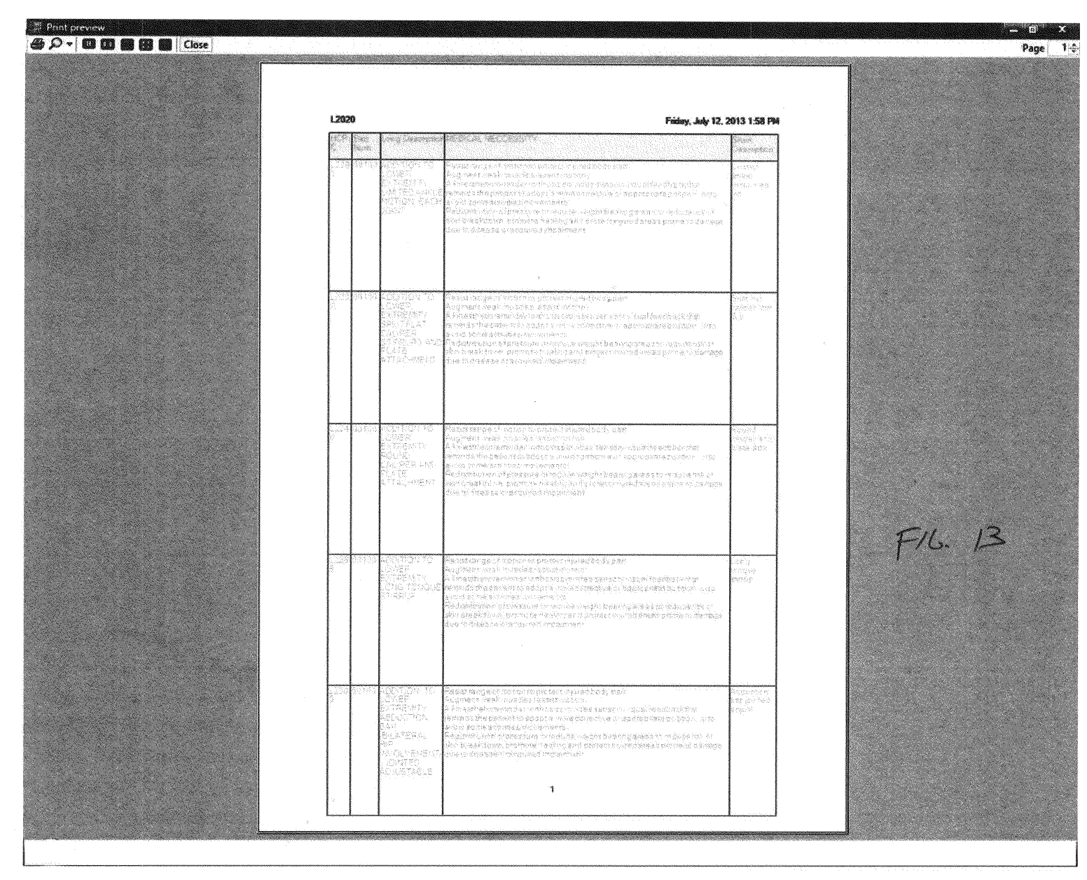

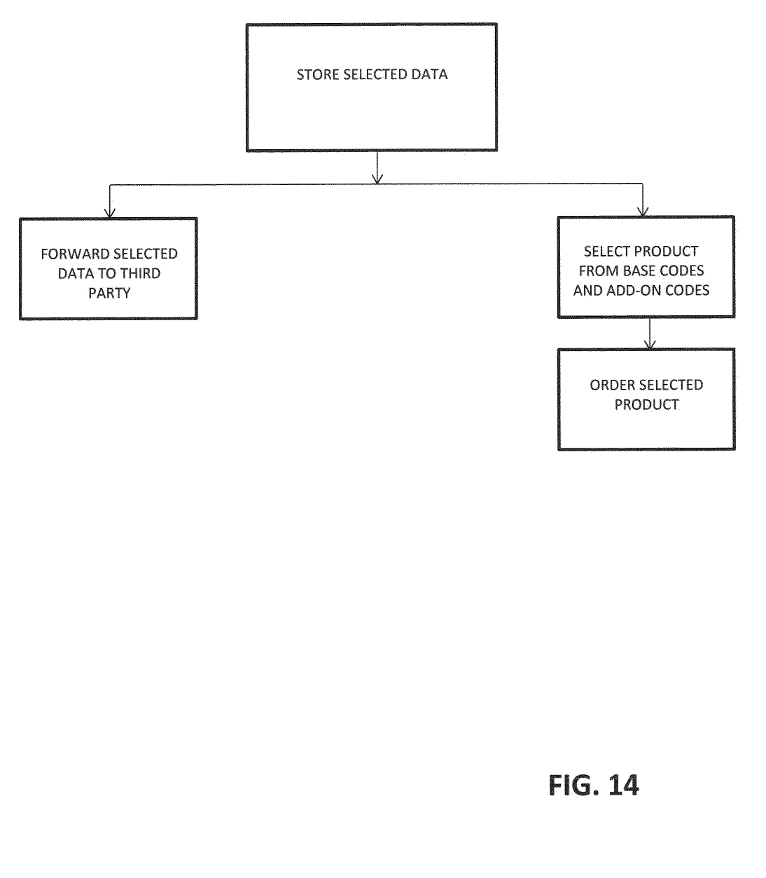

The biller or coder user can then choose and order products 24 and 32 for a particular patient from the menus provided using the base codes 14 and add-on codes 18, as well as the descriptions 20 and medical necessities 22 for such codes (FIG. 14). The biller or coder is essentially building a device for the patient from the base code 14 and add-on codes 18 and the provided menus. These selections are stored in memory 28, and orders for the correct products for a particular patient can be placed with the various manufacturers via email. Additionally, the information stored can be printed (FIG. 13), and provided to third party payers such as insurance companies, managed care organizations, doctors, purchasing departments via email with information needed to complete product selection, ordering and billing (FIG. 14). The information stored includes patient information such as name, address, referring doctor, insurance information, and the like, in addition to the selected coding and product information. The process of the present invention can be used with medical and billing coders in medical professional offices, as well as in connection with mobile devices.

While the specific embodiments have been illustrated and described, numerous modifications come to mind without significantly departing from the spirit of the invention, and the scope of protection is only limited by the scope of the accompanying Claims.

What is claimed is:

1. A medical billing and coding process comprising the steps of:
storing medical base codes, descriptions of the medical base codes, images corresponding to the medical base codes, medical justifications for the medical base codes, and product information corresponding to each medical base code;
providing the medical base code descriptions when a medical base code is selected;
providing medical justifications corresponding to the selected medical base code;
providing products corresponding to the selected medical base code;
providing ordering information for the products corresponding to the selected medical base code; and
rendering the image corresponding to the medical base code such that additional medical codes, descriptions of the additional medical codes, and additional products associated with the additional medical codes may be viewed and selected from the image.

2. The process of claim 1 wherein the additional medical codes include add-on codes.

3. The process of claim 2 further comprising providing the add-on codes when a base code is selected.

4. The process of claim 1 further comprising the step of storing the selected information.

5. The process of claim 1 further comprising the step of forwarding the stored selected information to a third party.

6. The process of claim 1 further comprising the step of selecting a product associated with the medical base code and additional medical codes.

7. The process of claim 6 further comprising the step of ordering the selected product corresponding to the medical base code and additional medical codes.

8. The process of claim 5 wherein the third party is a third party payer.

9. The process of claim 4 wherein the stored information includes patient information.

10. A medical billing and coding process comprising the steps of:
storing medical base codes, descriptions of the medical base codes, images corresponding to the medical base codes, medical justifications for the medical base codes, and ordering and pricing information corresponding to the products;
selecting at least one medical base code;
rendering the image corresponding to the medical base code, the image including selectable portions such that a menu of the base code descriptions is provided when a first portion is selected from the image;
providing the medical justifications for the selected base code;
providing products corresponding to the medical base code;
providing additional medical codes corresponding to the medical base code; and
providing ordering information for the products.

11. The process of claim 10 wherein the additional medical codes include add-on codes.

12. The process of claim 11 further comprising providing the add-on codes when a base code is selected.

13. The process of claim 10 further comprising the step of storing the selected information.

14. The process of claim 10 further comprising the step of forwarding the stored selected information to a third party.

15. The process of claim 10 further comprising the step of selecting a product associated with the medical base code and additional medical codes.

16. The process of claim 10 further comprising the step of ordering the selected product corresponding to the medical base code and additional medical codes.

17. The process of claim 14 wherein the third party is a third party payer.

18. The process of claim 13 wherein the stored information includes patient information.
